(19) United States
(12) Patent Application Publication
(10) Pub. No.: US 2025/0033641 A1
(43) Pub. Date: Jan. 30, 2025

(54) METHOD FOR SAFEGUARDING A DRIVING BEHAVIOR OF A VEHICLE BY PROVIDING AN EMERGENCY STOP TRAJECTORY FOR THE VEHICLE

(71) Applicant: Robert Bosch GmbH, Stuttgart (DE)

(72) Inventors: Armin Joos, Stuttgart (DE); Joram Berger, Heimsheim (DE); Markus Schuetz, Tuebingen (DE); Miriam Nienhueser, Renningen (DE)

(21) Appl. No.: 18/769,494

(22) Filed: Jul. 11, 2024

(30) Foreign Application Priority Data
Jul. 26, 2023 (DE) 10 2023 207 094.4

(51) Int. Cl. B60W 30/18; B60W 30/095

(52) U.S. Cl. CPC B60W 30/18009; B60W 30/095; B60W 2520/04; B60W 2520/06

(57) ABSTRACT

A method for safeguarding a driving behavior of a vehicle by providing an emergency stop trajectory for the vehicle. A computer program, a device, and a storage medium for this purpose are also described.

### CROSS REFERENCE

The present application claims the benefit under 35 U.S.C. § 119 of German Patent Application No. DE 10 2023 207 094.4 filed on Jul. 26, 2023, which is expressly incorporated herein by reference in its entirety.

### FIELD

The present invention relates to a method for safeguarding a driving behavior of a vehicle by providing an emergency stop trajectory for the vehicle. The present invention furthermore relates to a computer program, a device, and a storage medium for this purpose.

### BACKGROUND INFORMATION

In the context of autonomous vehicles, ensuring driving trajectories is becoming increasingly important. For example, numerous existing systems use the methodology of generating additional parallel paths to the main path, which additional paths are created using an independent planning algorithm. As a result, these systems can be very complex and expensive even without a safeguarding logic for the trajectory.

An alternative approach could be to safeguard the area that can be reached in an extreme case, such as when the steering wheel is at a maximum steering angle. In such scenarios, there may be no need for an additional planning algorithm; however, it should be taken into account that the potentially reachable area of the vehicle can expand significantly. This may result in driving behavior that maintains large lateral distances from objects, which could be difficult to implement in practice.

### SUMMARY

The present invention includes a method, a computer program, a device, and a computer-readable storage medium. Features of and details relating to the present invention can be found in the disclosure herein. Features and details which are described in connection with the method according to the present invention of course also apply in connection with the computer program according to the present invention, the device according to the present invention, and the computer-readable storage medium according to the present invention, and respectively vice versa, so that, with respect to the disclosure, mutual reference is or can be made to the individual aspects of the present invention at all times.

The present invention particularly relates to a method for safeguarding a driving behavior of a vehicle by providing an emergency stop trajectory for the vehicle. According to an example embodiment of the present invention, the method includes the following steps:
providing a main trajectory of the vehicle, wherein the main trajectory describes a movement path of a regular movement of the vehicle,
generating at least one preliminary trajectory based on the main trajectory, wherein the at least one preliminary trajectory describes a stopping process of the vehicle,
checking the at least one generated preliminary trajectory using at least one criterion to evaluate whether the generated preliminary trajectory is suitable as the emergency stop trajectory for an emergency stop maneuver of the vehicle, wherein the at least one criterion is specific to driving safety during the emergency stop maneuver and/or to drivability of the emergency stop maneuver by the vehicle, wherein the emergency stop trajectory describes a movement path for the emergency stop maneuver of the vehicle,
providing the emergency stop trajectory on the basis of the check in order to safeguard the driving behavior of the vehicle by means of the provided emergency stop trajectory.

In the context of the present invention, a trajectory is preferably a course of a spatial curve along which a body, i.e., in particular the vehicle, moves. For example, a center of gravity of the body is used to describe the trajectory. An emergency stop maneuver is, for example, full braking of the vehicle or specific steering. Simply put, the regular movement can be understood as the normal driving of the vehicle. Driving safety can, for example, mean that no vehicle occupants or pedestrians are injured. Drivability can mean that the emergency stop maneuver can be carried out mechanically by the vehicle. Generating the at least one preliminary trajectory on the basis of the main trajectory can be advantageous because the underlying data means that no new calculation is necessary and thus the computational effort can be advantageously reduced. This can be particularly advantageous because the calculation of the main trajectory can be based on a complex planning algorithm. Furthermore, it is possible that the main trajectory does not specifically take driving safety into account, so that this is advantageously taken into account with the emergency stop trajectory.

According to a further advantage of the present invention, it can be provided that the movement path of the main trajectory describes a longitudinal and a transverse movement of the vehicle, wherein a transverse movement of the at least one generated preliminary trajectory coincides with the transverse movement of the main trajectory. By limiting the generation of the preliminary trajectory to the longitudinal movement, the amount of data to be processed and thus the computational effort can be reduced.

It can be provided within the scope of the present invention that the step of generating the at least one preliminary trajectory comprises generating at least two preliminary trajectories in which the stopping process described by the respective preliminary trajectory is varied. This makes it possible to advantageously test and check different scenarios, or braking maneuvers, with respect to the at least one criterion, by means of the respective preliminary trajectory.

Furthermore, within the scope of the present invention, it is optionally possible for the step of generating to be carried out during a journey of the vehicle and the varying of the stopping process to be carried out at least depending on a current speed of the vehicle. Since the current speed can have an influence on the stopping process, it is advantageous to vary the stopping process taking the current speed into account. For example, it may be provided that certain emergency stopping maneuvers are provided for certain speeds.

In addition, within the scope of the present invention, it is possible that the stopping process is varied at least depending on a system latency of the vehicle in order to ensure that the relevant preliminary trajectory takes the system latency into account and/or is collision-free taking the system latency into account. System latency can be a delay caused by calculations done by the vehicle, for example by the vehicle's on-board computer. These calculations can cause the system latency to vary depending on the load and said latency can be taken into account individually when generating the relevant preliminary trajectory.

It may also be possible that the at least one criterion is selected from at least one of the following:
the drivability of the relevant preliminary trajectory, wherein the drivability indicates whether the relevant preliminary trajectory can be realized by a longitudinal and transverse guidance of the vehicle,
a permissible occupied area of the vehicle along the relevant preliminary trajectory, wherein the permissible occupied area preferably indicates a predefined area of the vehicle's surroundings,
a freedom from collision of the vehicle along the relevant preliminary trajectory, wherein the freedom from collision preferably assesses a risk of collision of the vehicle with one or more road users or at least one static object.

The permissible occupied area can be specified by the vehicle, e.g., a vehicle's own lane, a roadway or a mapped area. The possible occupied area of the vehicle results, for example, from the area that the vehicle possibly covers when traveling the trajectory, taking into account the inaccuracies for control and localization. When the freedom from collision is being checked, it is preferably assessed how great the risk of colliding with one or more objects involved in traffic is during the realization of the trajectory. Preferably, all objects, both moving and stationary (e.g., a parked vehicle or a construction site traffic light), are taken into account. During the check, both the inaccuracies of the vehicle's own control and localization in the realization of the trajectory as well as the inaccuracies of the object determination and the predicted behavior of the objects can be taken into account. A static object can be, for example, a bridge pier.

Furthermore, it is possible that after a defined period of time, the at least one preliminary trajectory is generated as a current preliminary trajectory, wherein, in the event that a result of checking the current preliminary trajectory using the at least one criterion indicates that the current preliminary trajectory is not suitable as the emergency stop trajectory, the method further comprises the following step:
controlling the vehicle along the preliminary trajectory which was generated prior to the current preliminary trajectory.

Within the scope of the present invention, it can also generally be provided that an updated preliminary trajectory is respectively generated after a defined period of time. This approach advantageously makes it possible to continuously check whether the at least one criterion is fulfilled and, if it is not fulfilled, to react promptly by steering the vehicle along the previous preliminary trajectory. The previous preliminary trajectory, which precedes the current preliminary trajectory in time, has in particular fulfilled the at least one criterion.

The vehicle may be configured, for example, as a motor vehicle and/or passenger vehicle and/or autonomous vehicle. The vehicle may comprise a vehicle apparatus, for example for providing an autonomous driving function and/or a driver assistance system. The vehicle apparatus may be designed to at least partially automatically control and/or accelerate and/or brake and/or steer the vehicle.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for data processing that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example. Furthermore, the method according to the present invention can also be carried out as a computer-implemented method.

Further advantages, features and details of the present invention can be found in the following description, in which exemplary embodiments of the present invention are described in detail with reference to the figures. The features mentioned in in the disclosure herein can be essential to the present invention, individually or in any combination.

### BRIEF DESCRIPTION OF THE DRAWINGS

FIG. 1 is a schematic visualization of a vehicle, a method, a device, a storage medium and a computer program according to exemplary embodiments of the present invention.

FIG. 2 shows a schematic representation of a method according to an exemplary embodiment of the present invention.

### DETAILED DESCRIPTION OF EXAMPLE EMBODIMENTS

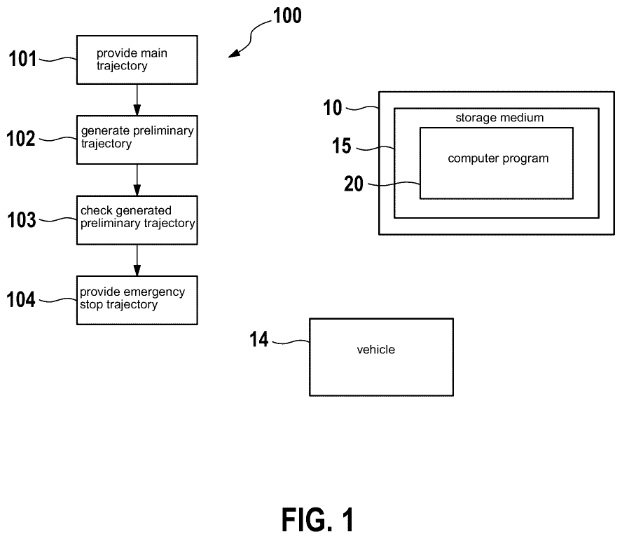

FIG. 1 schematically shows a vehicle 14, a method 100, a device 10, a storage medium 15, and a computer program 20 according to exemplary embodiments of the present invention.

In accordance with the method 100 according to the exemplary embodiment in FIG. 1, in a first step 101 a main trajectory 4 of the vehicle 14 is provided, wherein the main trajectory 4 describes a movement path of a regular movement of the vehicle 14. In a second step 102, at least one preliminary trajectory is generated on the basis of the main trajectory 4, wherein the at least one preliminary trajectory describes a stopping process of the vehicle 14. In a third step 103, the at least one generated preliminary trajectory is checked using at least one criterion to evaluate whether the generated preliminary trajectory is suitable as the emergency stop trajectory 5 for an emergency stop maneuver of the vehicle 14. The at least one criterion is specific to driving safety and/or drivability during the emergency stop maneuver. The emergency stop trajectory 5 describes in particular a movement path for the emergency stop maneuver of the vehicle 14. In a fourth step 104, the suitable emergency stop trajectory 5 is provided on the basis of the check in order to safeguard the driving behavior of the vehicle 14 by means of the provided emergency stop trajectory 5.

The present invention is based in particular on an approach in which a planning algorithm with regard to the transverse movement of the vehicle can be dispensed with, but a potential occupied area of the vehicle can nevertheless be restricted. This can significantly reduce the complexity of an AD system (automated driving system) and the associated safeguarding effort.

Automated vehicles, for example, have the task of relieving the driver of the driving task or of taking over this task in order to temporarily or completely free the driver of the driving task. Therefore, these systems have particularly high safety requirements, including with regard to their availability, reliability and integrity, and also, in particular, high SOTIF (safety of the intended functionality) requirements. An automated driving system (AD system), for example, comprises many different software and hardware components that may be needed to detect the situation (e.g., vehicle state estimation, environmental detection, localization), to create an environmental model including planning the vehicle's own behavior (e.g., fusion, situational analysis and assessment, planning) and to implement the planned behavior (longitudinal and transverse control). Planning the vehicle's behavior preferably plays a role here, since planning may take into account not only the vehicle's destination but also the behavior of other road users and traffic regulations. The planned behavior can be described by a trajectory.

In order to be able to achieve this task, elaborate and complex algorithms may be used in the planning process. This fact results, in particular, in an enormous safeguarding effort. For an automated vehicle for which the execution of an emergency stop maneuver in the event of a detected error is sufficient, the safeguarding effort can be significantly reduced by exemplary embodiments of the present invention. For this purpose, a second execution path, the so-called safeguarding path or the emergency stop trajectory, can be generated and used parallel to the main execution path, which calculates the planned trajectory and, in the context of the present invention, is also called the main path or main trajectory. The safeguarding path, or the emergency stop trajectory, preferably contains all modules that are required to ensure the safety requirements. If the emergency stop trajectory does not detect a violation of a safety objective, the vehicle is preferably controlled via the planned behavior of the main trajectory. However, if a violation of a safety objective is detected, the vehicle control system takes over and carries out the emergency stop maneuver along the emergency stop trajectory. In addition, it may be the case that the activation of the system, in particular of the vehicle, is only possible if no violation of a safety objective has been detected. This can allow both safeguarded and non-safeguarded modules to be used in the main path.

One aspect of this present invention is in particular the extension of the vehicle automation system by a parallel path. This parallel path preferably calculates, based on the trajectory of the main path, at least one preliminary trajectory in order to determine a safe emergency stop trajectory 5 and thus advantageously ensures the safety of the system. In addition to safeguarding the emergency stop trajectory 5, which is described below, the use of a safe steering and braking system in the parallel path can be responsible for safe implementation of the trajectory. This makes it possible, for example, to use a main path procedure with increased validation effort.

The separate safeguarding in the parallel path can be achieved by the following steps. A calculation of an emergency stop trajectory 5 based on an arbitrary trajectory by superimposing different braking maneuvers (e.g., consideration of different emergency stop braking maneuvers also depending on the speed range). With regard to their transverse movement, the emergency stop trajectories 5 preferably remain on the main trajectory 4. Taking system latencies into account can ensure that the emergency stop trajectories 5 are still collision-free in the next time step. A further step can be to check the safety requirements by validating the emergency stop trajectories 5 through modular checks. These preferably evaluate each emergency stop trajectory 5 with regard to its drivability 8, its permissible occupied area 6 and its freedom from collisions. If an emergency stop trajectory 5 satisfies all checks, it can be considered safe. As a further step, the target trajectory can be selected, preferably in the decision maker 11. The latter takes over in particular the main trajectory 4 if at least one safe emergency stop trajectory 5 exists. Otherwise, the emergency stop trajectory 5 with the lowest collision risk from the last time step is preferably selected as the target trajectory. The concept can have a modular architecture, which enables use in different hardware architectures. In particular, it allows system uncertainties, e.g., localization inaccuracy, inaccuracy of vehicle movement determination or system latencies, to be easily taken into account when calculating emergency stop trajectories 5 or in safety checks. An additional planning algorithm for transverse movement, including planning and safeguarding a steering movement, can be dispensed with. This reduces the overall complexity, for example, and can therefore allow the concept to be implemented on smaller processors. Due to the modular design, the concept can be easily adapted, for example by further checks, e.g., compliance with traffic regulations or only carrying out maneuvers according to the system specification.

In one exemplary embodiment of the present invention, a simplified module is used in the safeguarding path, which module uses any input trajectory, which does not necessarily have to be safeguarded, to calculate an emergency stop trajectory 5 with which safe system behavior can be provided. This module preferably includes a calculation of the emergency stop trajectories 5, a trajectory evaluation and a decision maker 11.

The sub-module “Calculation of Emergency Stop Trajectories” uses in particular the planned trajectory from the main path, i.e., the main trajectory, as input. The longitudinal movement of the trajectory can be recalculated by using the longitudinal behavior of the emergency stop maneuver, starting at the time of activation, as the basis for the trajectory instead of the previous longitudinal behavior. The time of activation is calculated, for example, from the current time, including the maximum cycle time for the entire module. The result of the calculation is preferably an emergency stop trajectory 5 which has the same transverse movement as the input trajectory and ends in standstill. By varying the braking behavior for the emergency stop maneuver, instead of one emergency stop trajectory 5, a group of emergency stop trajectories 5 can be obtained, all of which may have the same transverse movement as the input trajectory. The variation in braking behavior results in particular from the minimum and maximum requirements for the emergency stop maneuver. The minimum requirements are preferably derived from the emergency stop maneuver, which the vehicle 14 must be able to perform at any time in the current driving state, provided that it is within the system boundaries/ODD (operational design domain). The maximum requirements for the emergency stop maneuver are preferably derived from the strongest emergency braking maneuver permissible for the automated vehicle 14 in the current driving state to come to a standstill.

The transverse behavior of the input trajectory is preferably used as a basis to calculate the emergency stop trajectories 5. In particular, this means that no additional planning algorithm is required with regard to the transverse movement in the safeguarding path, which, depending on the area of application (operational design domain (ODD)) of networked and autonomous vehicles 14, can be very complex and thus significantly increase the safeguarding effort. By doing without, the total computing time of the safeguarding path can also be reduced, which can reduce the reaction time of the system, especially in critical situations that happen suddenly.

The “Trajectory Evaluation” sub-module preferably checks each of the calculated emergency stop trajectories 5 with regard to their drivability 8, their permissible occupied area 6 and their freedom from collisions. When checking drivability 8, preference is given to assessing whether the trajectory can be realized by the downstream longitudinal and transverse guidance and whether they move within the system limits. These can be, for example, tests, such as changes in the longitudinal or transverse behavior when regulating the trajectory within the realizable limits, or an exceeding of the possible total force on the wheel, taking into account the cornering force in the transverse direction and the braking or driving force in the longitudinal direction of the wheel, until the maximum friction force is reached. Furthermore, it can be tested whether longitudinal and transverse movements remain within the system limits at all times.

Only if all checks are fulfilled does the trajectory preferably pass the check for drivability 8, otherwise it does not. When the permissible occupied area 6 is being checked, it is assessed in particular whether the possible occupied area 6 of the vehicle 14 is located within the occupied area 6 permitted by the system at any time during the trajectory. The permitted occupied area 6 can be specified by the AD system, e.g., the vehicle's own lane, the roadway or a mapped area. The possible occupied area 6 of the vehicle 14 results, for example, from the area which the vehicle 14 may possibly cover when traveling along the trajectory, taking into account the inaccuracies for control and localization. If the trajectory passes this check, it can pass the check for the occupied area 6, otherwise it does not. When the freedom from collision is being checked, it is preferably assessed how great the risk of colliding with one or more objects involved in traffic is during the realization of the trajectory. Preferably, all objects, both moving and stationary (e.g., a parked vehicle 14 or a construction site traffic light) are taken into account. During the check, both the inaccuracies of the vehicle's own control and localization in realizing the trajectory as well as the inaccuracies of determining the object and the predicted behavior of the objects can be taken into account. The check for freedom from collisions is preferably considered to have been passed if, taking into account the above-mentioned inaccuracies, a collision 7 can be safely excluded. Otherwise, freedom from collision is not guaranteed and the check is deemed to have been failed. In this case, the ascertained risk of collision can also be made available.

The sub-module “Decision Maker” 11 preferably evaluates the results of the “Trajectory Evaluation”. If there is at least one trajectory that has passed all checks, it can currently be ensured that at least one safe emergency stop trajectory 5 exists in the next time step. In this case, the safety path preferably behaves passively. If none of the trajectories fulfills all checks, a safety objective is potentially violated and the safety path can take over vehicle control, wherein the emergency stop trajectory 5 with the lowest collision risk from the last time step is preferably transferred to the vehicle control. This can still be safe because the cycle time was taken into account when calculating the emergency stop trajectories 5.

The present invention described is preferably modular and can be extended to include checks for additional safety objectives, if required. For example, if there are safety objectives for the automated vehicle 14 that require compliance with traffic regulations, e.g., compliance with right-of-way rules, it is possible to integrate a further check in the “Trajectory Evaluation” sub-module, which checks this safety objective. The result of the check can then be taken into account accordingly in the “Decision Maker” sub-module 11. The described concept can be further extended by using, in addition to the planned trajectory, further trajectories as input into the sub-module “Calculation of Emergency Stop Trajectories” 5, which include other transverse movements. This increases in particular the options for action for the safety path, and thus the existence of at least one emergency stop trajectory 5 which passes all checks.

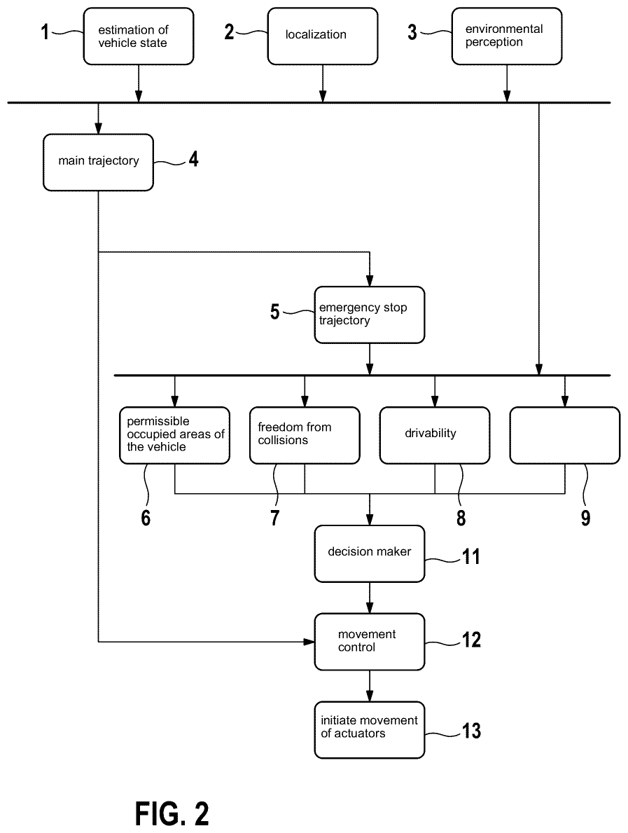

FIG. 2 schematically shows one possible exemplary embodiment of the method. In particular, values, such as an estimate of the vehicle state 1, localization 2 and environmental perception 3, are included in the provision of the main trajectory 4. The emergency stop trajectory 5 is preferably generated on the basis of the main trajectory 4. This can be assessed using the criteria of drivability 8, a permissible occupied area of the vehicle 6, and freedom from collisions 7. A decision maker 11 then preferably makes a decision as to whether a safe emergency stop trajectory 4 is present or whether an emergency stop trajectory 4 with the highest freedom from collisions 7 is selected. In a next step, a movement control 12 can be executed, which initiates a movement of various actuators 13 of the vehicle by means of corresponding values.

The above description of the embodiments describes the present invention exclusively in the context of examples. Of course, individual features of the embodiments of the present invention, provided they make technical sense, can be freely combined with one another without departing from the scope of the present invention.

What is claimed is:

1. A method for safeguarding a driving behavior of a vehicle by providing an emergency stop trajectory for the vehicle, comprising the following steps:
providing a main trajectory of the vehicle, wherein the main trajectory describes a movement path of a regular movement of the vehicle;
generating at least one preliminary trajectory based on the main trajectory, wherein the at least one preliminary trajectory describes a stopping process of the vehicle;
checking the at least one generated preliminary trajectory using at least one criterion to evaluate whether the generated preliminary trajectory is suitable as the emergency stop trajectory for an emergency stop maneuver of the vehicle, wherein the at least one criterion is specific to: (i) driving safety during the emergency stop maneuver, and/or (ii) drivability of the emergency stop maneuver by the vehicle, wherein the emergency stop trajectory describes a movement path for the emergency stop maneuver of the vehicle; and
providing the emergency stop trajectory based on the checking in order to safeguard the driving behavior of the vehicle via the provided emergency stop trajectory.

2. The method according to claim 1, wherein the movement path of the main trajectory describes a longitudinal and a transverse movement of the vehicle, wherein a transverse movement of the at least one generated preliminary trajectory coincides with the transverse movement of the main trajectory.

3. The method according to claim 1, wherein the step of generating the at least one preliminary trajectory includes generating at least two preliminary trajectories in which a stopping process described by each of the preliminary trajectory is varied.

4. The method according to claim 3, wherein the step of generating is carried out during a journey of the vehicle and the varying of the stopping process is carried out at least depending on a current speed of the vehicle.

5. The method according to claim 3, wherein the varying of the stopping process is carried out at least depending on a system latency of the vehicle in order to ensure that the preliminary trajectory: (i) takes the system latency into account, and/or (ii) is collision-free taking the system latency into account.

6. The method according to claim 1, wherein the at least one criterion is at least one of the following:
drivability of the preliminary trajectory, wherein the drivability of the preliminary trajectory indicates whether the preliminary trajectory can be realized by a longitudinal and a transverse guidance of the vehicle,
a permissible occupied area of the vehicle along the preliminary trajectory, wherein the permissible occupied area indicates a predefined area of surroundings of the vehicle,
a freedom from collision of the vehicle along the preliminary trajectory, wherein the freedom from collision assesses a risk of collision of the vehicle with: (i) one or more road users, or (ii) at least one static object.

7. The method according to claim 1, wherein after a defined period of time, the at least one preliminary trajectory is generated as a current preliminary trajectory, wherein, in the event that a result of checking the current preliminary trajectory using the at least one criterion indicates that the current preliminary trajectory is not suitable as the emergency stop trajectory, the following step is performed:
controlling the vehicle along a preliminary trajectory which was generated prior to the current preliminary trajectory.

8. A device for data processing configured to safeguard a driving behavior of a vehicle by providing an emergency stop trajectory for the vehicle, the device configured to:
provide a main trajectory of the vehicle, wherein the main trajectory describes a movement path of a regular movement of the vehicle;
generate at least one preliminary trajectory based on the main trajectory, wherein the at least one preliminary trajectory describes a stopping process of the vehicle;
check the at least one generated preliminary trajectory using at least one criterion to evaluate whether the generated preliminary trajectory is suitable as the emergency stop trajectory for an emergency stop maneuver of the vehicle, wherein the at least one criterion is specific to: (i) driving safety during the emergency stop maneuver, and/or (ii) drivability of the emergency stop maneuver by the vehicle, wherein the emergency stop trajectory describes a movement path for the emergency stop maneuver of the vehicle; and
provide the emergency stop trajectory based on the checking in order to safeguard the driving behavior of the vehicle via the provided emergency stop trajectory.

9. A non-transitory computer-readable storage medium on which is stored a computer program including commands for safeguarding a driving behavior of a vehicle by providing an emergency stop trajectory for the vehicle, the commands, when executed by a computer, causing the computer to perform the following steps:
providing a main trajectory of the vehicle, wherein the main trajectory describes a movement path of a regular movement of the vehicle;
generating at least one preliminary trajectory based on the main trajectory, wherein the at least one preliminary trajectory describes a stopping process of the vehicle;
checking the at least one generated preliminary trajectory using at least one criterion to evaluate whether the generated preliminary trajectory is suitable as the emergency stop trajectory for an emergency stop maneuver of the vehicle, wherein the at least one criterion is specific to: (i) driving safety during the emergency stop maneuver, and/or (ii) drivability of the emergency stop maneuver by the vehicle, wherein the emergency stop trajectory describes a movement path for the emergency stop maneuver of the vehicle; and
providing the emergency stop trajectory based on the checking in order to safeguard the driving behavior of the vehicle via the provided emergency stop trajectory.
